(19) United States
(12) Patent Application Publication
(10) Pub. No.: US 2016/0336578 A1
(43) Pub. Date: Nov. 17, 2016

(54) FEATURES FOR PREVENTING SHORT CIRCUIT IN A BATTERY MODULE

(71) Applicant: Johnson Controls Technology Company, Holland, MI (US)

(72) Inventors: Robert J. Mack, Milwaukee, WI (US); Richard M. DeKeuster, Racine, WI (US); Jennifer L. Czarnecki, Franklin, WI (US); Michael L. Thompson, East Troy, WI (US); Jonathan P. Lobert, Hartford, WI (US)

(21) Appl. No.: 14/709,061

(22) Filed: May 11, 2015

(51) Int. Cl. H01M 2/34; H01M 2/22; H01M 10/0525; H01M 2/30; H01M 2/20

(52) U.S. Cl. CPC H01M 2/34; H01M 2/305; H01M 2/206; H01M 10/0525; H01M 2/22; H01M 2220/20

(57) ABSTRACT

The present disclosure includes a battery module having a first battery cell with a first cell terminal, a second battery cell with a second cell terminal, a first adapter disposed about the first cell terminal, where the first adapter has a first recess positioned proximate to the first cell terminal, and a second adapter disposed about the second cell terminal, wherein the second adapter has a second recess positioned proximate to the second cell terminal The battery module also includes a bus bar configured to electrically couple the first cell terminal to the second cell terminal via the first and second recesses and an electrically insulative shield configured to cover the first cell terminal and the second cell terminal when the bus bar is being coupled to the first and second recesses to prevent a short circuit.

### BACKGROUND

The present disclosure relates generally to the field of batteries and battery modules. More specifically, the present disclosure relates to features that may prevent short circuit events when assembling a battery module.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

A vehicle that uses one or more battery systems for providing all or a portion of the motive power for the vehicle can be referred to as an xEV, where the term “xEV” is defined herein to include all of the following vehicles, or any variations or combinations thereof, that use electric power for all or a portion of their vehicular motive force. For example, xEVs include electric vehicles (EVs) that utilize electric power for all motive force. As will be appreciated by those skilled in the art, hybrid electric vehicles (HEVs), also considered xEVs, combine an internal combustion engine propulsion system and a battery-powered electric propulsion system, such as 48 Volt (V) or 130V systems. The term HEV may include any variation of a hybrid electric vehicle. For example, full hybrid systems (FHEVs) may provide motive and other electrical power to the vehicle using one or more electric motors, using only an internal combustion engine, or using both. In contrast, mild hybrid systems (MHEVs) disable the internal combustion engine when the vehicle is idling and utilize a battery system to continue powering the air conditioning unit, radio, or other electronics, as well as to restart the engine when propulsion is desired. The mild hybrid system may also apply some level of power assist, during acceleration for example, to supplement the internal combustion engine. Mild hybrids are typically 96V to 130V and recover braking energy through a belt or crank integrated starter generator. Further, a micro-hybrid electric vehicle (mHEV) also uses a “Stop-Start” system similar to the mild hybrids, but the micro-hybrid systems of a mHEV may or may not supply power assist to the internal combustion engine and operates at a voltage below 60V. For the purposes of the present discussion, it should be noted that mHEVs typically do not technically use electric power provided directly to the crankshaft or transmission for any portion of the motive force of the vehicle, but an mHEV may still be considered an xEV since it does use electric power to supplement a vehicle's power needs when the vehicle is idling with internal combustion engine disabled and recovers braking energy through an integrated starter generator. In addition, a plug-in electric vehicle (PEV) is any vehicle that can be charged from an external source of electricity, such as wall sockets, and the energy stored in the rechargeable battery packs drives, or contributes to drive, the wheels. PEVs are a subcategory of EVs that include all-electric or battery electric vehicles (BEVs), plug-in hybrid electric vehicles (PHEVs), and electric vehicle conversions of hybrid electric vehicles and conventional internal combustion engine vehicles.

xEVs as described above may provide a number of advantages as compared to more traditional gas-powered vehicles using only internal combustion engines and traditional electrical systems, which are typically 12V systems powered by a lead acid battery. For example, xEVs may produce fewer undesirable emission products and may exhibit greater fuel efficiency as compared to traditional internal combustion vehicles and, in some cases, such xEVs may eliminate the use of gasoline entirely, as is the case of certain types of EVs or PEVs.

As technology continues to evolve, there is a need to provide improved power sources, particularly battery modules, for such vehicles. For example, traditional configurations of battery modules may include exposed, electrical connections between terminals of electrochemical cells. The exposed connections may complicate manufacturing of the battery module by subjecting the battery module to an increased risk of a short circuit. This increased risk may create undesirable situations during manufacturing of the battery module.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure relates to a battery module having a first battery cell with a first cell terminal, a second battery cell with a second cell terminal, a first adapter disposed about the first cell terminal, where the first adapter has a first recess positioned proximate to the first cell terminal, and a second adapter disposed about the second cell terminal, wherein the second adapter has a second recess positioned proximate to the second cell terminal The battery module also includes a bus bar configured to electrically couple the first cell terminal to the second cell terminal via the first and second recesses and an electrically insulative shield configured to cover the first cell terminal and the second cell terminal when the bus bar is being coupled to the first and second recesses to prevent a short circuit.

The present disclosure also relates to a method for constructing a battery module that includes disposing a first adapter over a first battery cell terminal, where the first adapter covers at least a portion of the first battery cell terminal and has a first recess positioned proximate to the first battery cell terminal and disposing a second adapter over a second battery cell terminal, where the second adapter covers at least a portion of the second battery cell terminal and has a second recess positioned proximate to the second battery cell terminal. The method also includes covering a remaining exposed portion of the first battery cell terminal and a remaining exposed portion of the second battery cell terminal with an electrically insulative shield and electrically coupling the first battery cell terminal to the second battery cell terminal by disposing a bus bar within the first and second recesses.

The present disclosure also relates to a battery module that includes a first battery cell having a first cell terminal, a second battery cell having a second cell terminal, a first adapter covering at least a portion of the first cell terminal, where the first adapter has a first recess positioned proximate to the first cell terminal, a first conductive portion in contact with the first cell terminal, and a first insulative portion at least partially surrounding the first conductive portion, and a second adapter covering at least a portion of the second cell terminal, where the second adapter has a second recess positioned proximate to the second cell terminal, a second conductive portion in contact with the second cell terminal, and a second insulative portion at least partially surrounding the second conductive portion. The battery module also includes a bus bar electrically coupling the first cell terminal to the second cell terminal via the first and second conductive portions and an electrically insulative shield covering a remaining exposed portion of the first cell terminal and a remaining exposed portion of the second cell terminal when the bus bar is being coupled to the first and second recesses.

### DRAWINGS

Various aspects of this disclosure may be better understood upon reading the following detailed description and upon reference to the drawings in which:

FIG. 1 is a perspective view of a vehicle having a battery system configured in accordance with present embodiments to provide power for various components of the vehicle;

FIG. 2 is a cutaway schematic view of an embodiment of the vehicle and the battery system of FIG. 1;

FIG. 3 is a perspective view of an embodiment of a battery module for use in the vehicle of FIG. 1, having a bus bar connection assembly with an electrically insulative shield being positioned there above, in accordance with an aspect of the present disclosure;

FIG. 4 is a perspective view of the battery module of FIG. 3 having an electrically insulative shield, in accordance with an aspect of the present disclosure;

FIG. 5 is a side perspective view of a portion of a battery module having a bus bar connection assembly and electrically insulative shields, in accordance with an aspect of the present disclosure;

FIG. 6 is a top perspective view of a portion of the bus bar connection assembly of FIG. 3, in accordance with an aspect of the present disclosure;

FIG. 7 is a top perspective view of the portion of the bus bar connection assembly of FIG. 6 having an electrically insulative shield, in accordance with an aspect of the present disclosure;

FIG. 8 is a top view of a portion of the bus bar connection assembly of FIG. 3, in accordance with an aspect of the present disclosure;

FIG. 9 is a top view of the portion of the bus bar connection assembly of FIG. 8 having an electrically insulative shield, in accordance with an aspect of the present disclosure;

FIG. 10 is a cross-sectional side view of a battery module, e-carrier, and bus bar connection assembly with an electrically insulative shield being positioned there over, in accordance with an aspect of the present disclosure;

FIG. 11 is a cross-sectional side view of the battery module of FIG. 10 having an electrically insulative shield in position over certain features, in accordance with an aspect of the present disclosure;

FIG. 12 is a cross-sectional side view of the battery module of FIG. 10 having another embodiment of an electrically insulative shield, in accordance with an aspect of the present disclosure; and

FIG. 13 is a flow chart of a process for assembling a battery module, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The battery systems described herein may be used to provide power to various types of electric vehicles (xEVs) and other high voltage energy storage/expending applications (e.g., electrical grid power storage systems). Such battery systems may include one or more battery modules, each battery module having a number of battery cells (e.g., Lithium-ion (Li-ion) electrochemical cells) arranged to provide particular voltages and/or currents useful to power, for example, one or more components of an xEV. As another example, battery modules in accordance with present embodiments may be incorporated with or provide power to stationary power systems (e.g., non-automotive systems).

Individual electrochemical cells of a battery module may be positioned in a housing, and terminals of the electrochemical cells may extend generally in a direction away from a base of the housing. To couple the electrochemical cells together (e.g., in series or parallel), an electrical path between terminals of two or more electrochemical cells may be established by coupling the terminals via a bus bar (e.g., welding the bus bar to the terminals). However, coupling the terminals may be difficult when the cells are different sizes (e.g., within a manufacturing tolerance). Therefore, adapters with metallic portions may be placed over adjacent terminals of two electrochemical cells. The adapters, in a general sense, increase a surface area of the cells available for electrical interconnections, thereby facilitating manufacture of the battery module. The adapters may each include a recess (e.g., recessed downwardly from a top surface of the adapter) configured to be aligned with an adjacent adapter's recess and to receive a bus bar. The bus bar may be disposed within the aligned recesses of the two adapters, such that the bus bar spans between the two adapters and contacts the metallic portions of the adjacent adapters, which each contact a respective terminal Accordingly, an electrical path is established from a first terminal, to a first adapter disposed around or over the first terminal, to the bus bar, to a second adapter disposed around or over a second terminal, and to the second terminal

By positioning the bus bar within the recesses of the two adapters to establish the electrical path between the two adapters (and, thus, the two terminals of which the two adapters are disposed around), the bus bar is located in plane with the terminal or below top surfaces of the two terminals. This positioning of the bus bar may reduce a clearance (e.g., a height) of the battery module as a whole, thereby reducing the volume and increasing the energy density of the battery module. For example, traditional configurations may include a bus bar above the terminals, which increases a total volume of the traditional configuration and can decrease energy density. Further, by positioning the bus bar within the recesses, and disposing plastic portions around the metallic portions of the adapters (particularly proximate the recesses of the adapters), the bus bar and the metallic portions of the adapters are protected from contact with other components (e.g., metal components) of, or proximate to, the battery module, thereby reducing a risk of a short circuit.

However, when coupling (e.g., welding) the bus bar to the metallic portions of the adapters, the terminals themselves are exposed. The exposed terminals may create a risk of a short circuit because a conductive component (e.g., weld spatter) may come into contact with the exposed terminal and interfere with the electrical path. A short circuit may be undesirable because a short circuit can cause damage to the battery cells. Therefore, an electrically insulative shield (e.g., a plastic shield) may be disposed over the exposed terminals of the battery cells when the bus bar is coupled (e.g., welded) to the metallic portions of the adapters. For example, the insulative shield may block a conductive component (e.g., weld spatter) from contacting the cell terminals, such that a short circuit may be prevented. It is now recognized that disposing an electrically insulative shield over terminal cells may be desirable because the electrically insulative shield may prevent short circuits, or reduce a likelihood of a short circuit occurring, during assembly of a battery module.

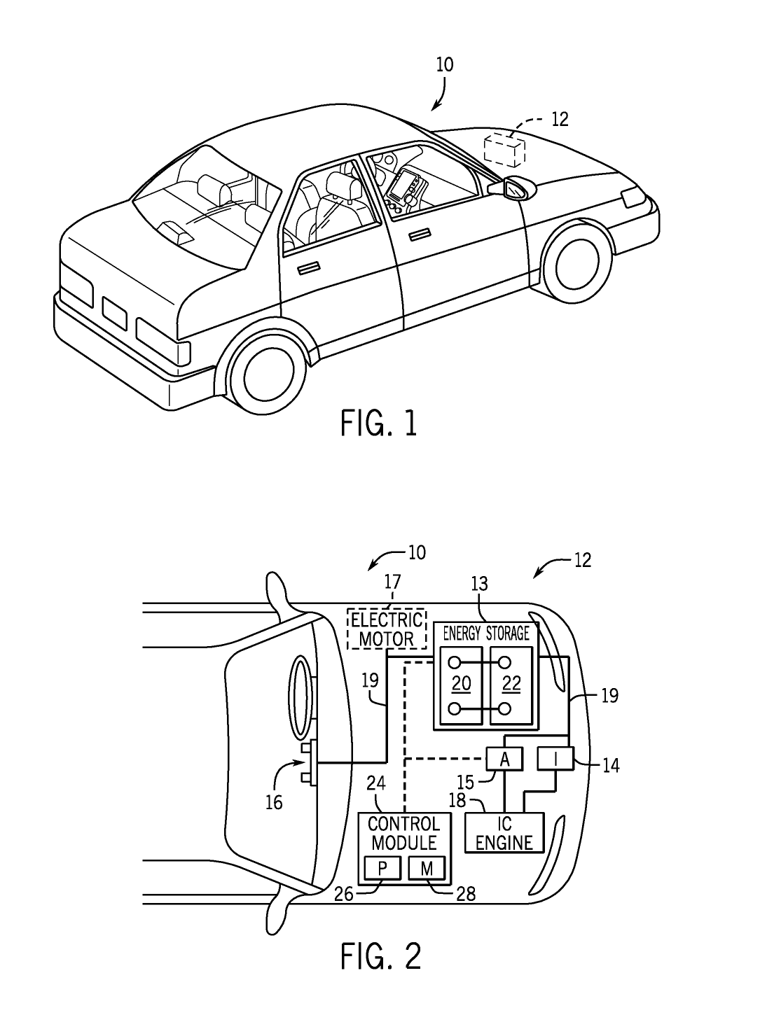

To help illustrate, FIG. 1 is a perspective view of an embodiment of a vehicle 10, which may utilize a regenerative braking system. Although the following discussion is presented in relation to vehicles with regenerative braking systems, the techniques described herein are adaptable to other vehicles that capture/store electrical energy with a battery, which may include electric-powered and gas-powered vehicles.

As discussed above, it would be desirable for a battery system 12 to be largely compatible with traditional vehicle designs. Accordingly, the battery system 12 may be placed in a location in the vehicle 10 that would have housed a traditional battery system. For example, as illustrated, the vehicle 10 may include the battery system 12 positioned similarly to a lead-acid battery of a typical combustion-engine vehicle (e.g., under the hood of the vehicle 10). Furthermore, as will be described in more detail below, the battery system 12 may be positioned to facilitate managing temperature of the battery system 12. For example, in some embodiments, positioning a battery system 12 under the hood of the vehicle 10 may enable an air duct to channel airflow over the battery system 12 and cool the battery system 12.

A more detailed view of the battery system 12 is described in FIG. 2. As depicted, the battery system 12 includes an energy storage component 13 coupled to an ignition system 14, an alternator 15, a vehicle console 16, and optionally to an electric motor 17. Generally, the energy storage component 13 may capture/store electrical energy generated in the vehicle 10 and output electrical energy to power electrical devices in the vehicle 10.

In other words, the battery system 12 may supply power to components of the vehicle's electrical system, which may include radiator cooling fans, climate control systems, electric power steering systems, active suspension systems, auto park systems, electric oil pumps, electric super/turbochargers, electric water pumps, heated windscreen/defrosters, window lift motors, vanity lights, tire pressure monitoring systems, sunroof motor controls, power seats, alarm systems, infotainment systems, navigation features, lane departure warning systems, electric parking brakes, external lights, or any combination thereof. Illustratively, in the depicted embodiment, the energy storage component 13 supplies power to the vehicle console 16 and the ignition system 14, which may be used to start (e.g., crank) an internal combustion engine 18.

Additionally, the energy storage component 13 may capture electrical energy generated by the alternator 15 and/or the electric motor 17. In some embodiments, the alternator 15 may generate electrical energy while the internal combustion engine 18 is running More specifically, the alternator 15 may convert the mechanical energy produced by the rotation of the internal combustion engine 18 into electrical energy. Additionally or alternatively, when the vehicle 10 includes an electric motor 17, the electric motor 17 may generate electrical energy by converting mechanical energy produced by the movement of the vehicle 10 (e.g., rotation of the wheels) into electrical energy. Thus, in some embodiments, the energy storage component 13 may capture electrical energy generated by the alternator 15 and/or the electric motor 17 during regenerative braking. As such, the alternator 15 and/or the electric motor 17 are generally referred to herein as a regenerative braking system.

To facilitate capturing and supplying electric energy, the energy storage component 13 may be electrically coupled to the vehicle's electric system via a bus 19. For example, the bus 19 may enable the energy storage component 13 to receive electrical energy generated by the alternator 15 and/or the electric motor 17. Additionally, the bus 19 may enable the energy storage component 13 to output electrical energy to the ignition system 14 and/or the vehicle console 16. Accordingly, when a 12 volt battery system 12 is used, the bus 19 may carry electrical power typically between 8-18 volts.

Additionally, as depicted, the energy storage component 13 may include multiple battery modules. For example, in the depicted embodiment, the energy storage component 13 includes a lithium ion (e.g., a first) battery module 20 and a lead-acid (e.g., a second) battery module 22, which each includes one or more battery cells. In other embodiments, the energy storage component 13 may include any number of battery modules. Additionally, although the lithium ion battery module 20 and lead-acid battery module 22 are depicted adjacent to one another, they may be positioned in different areas around the vehicle. For example, the lead-acid battery module 22 may be positioned in or about the interior of the vehicle 10 while the lithium ion battery module 20 may be positioned under the hood of the vehicle 10.

In some embodiments, the energy storage component 13 may include multiple battery modules to utilize multiple different battery chemistries. For example, when the lithium ion battery module 20 is used, performance of the battery system 12 may be improved since the lithium ion battery chemistry generally has a higher coulombic efficiency and/or a higher power charge acceptance rate (e.g., higher maximum charge current or charge voltage) than the lead-acid battery chemistry. As such, the capture, storage, and/or distribution efficiency of the battery system 12 may be improved.

To facilitate controlling the capturing and storing of electrical energy, the battery system 12 may additionally include a control module 24. More specifically, the control module 24 may control operations of components in the battery system 12, such as relays (e.g., switches) within energy storage component 13, the alternator 15, and/or the electric motor 17. For example, the control module 24 may regulate an amount of electrical energy captured/supplied by each battery module 20 or 22 (e.g., to de-rate and re-rate the battery system 12), perform load balancing between the battery modules 20 and 22, determine a state of charge of each battery module 20 or 22, determine temperature of each battery module 20 or 22, control voltage output by the alternator 15 and/or the electric motor 17, and the like.

Accordingly, the control unit 24 may include one or more processors 26 and one or more memory components 28. More specifically, the one or more processors 26 may include one or more application specific integrated circuits (ASICs), one or more field programmable gate arrays (FPGAs), one or more general purpose processors, or any combination thereof. Additionally, the one or more memory components 28 may include volatile memory, such as random access memory (RAM), and/or non-volatile memory, such as read-only memory (ROM), optical drives, hard disc drives, or solid-state drives. In some embodiments, the control unit 24 may include portions of a vehicle control unit (VCU) and/or a separate battery control module.

As discussed above, assembly of a battery module may be enhanced by utilizing a plastic or electrically insulative material (e.g., an electrically insulative shield) disposed over cell terminals to block short circuits when coupling (e.g., welding) a bus bar to cell terminal adapters. In certain embodiments, a ledge of the electrically insulative shield may extend over at least a portion of the adapters, but may generally leave space for insertion of the bus bars across adjacent adapters. Further, the ledge enables a welding tool to access a space directly above the bus bars after the bus bars are disposed across the adjacent adapters. Generally, each bus bar is disposed across adjacent adapters and welded to the adjacent adapters one at a time. After a first row of bus bars is coupled, the plastic block may be moved to another row of terminals and adapters, on the other side of a stack of electrochemical cells, to administer the coupling operation to the other row of bus bars. Additionally or alternatively, the battery module may include a second electrically insulative shield that may be disposed over the other row of terminals and adapters, such that the electrically insulative shield is not repositioned.

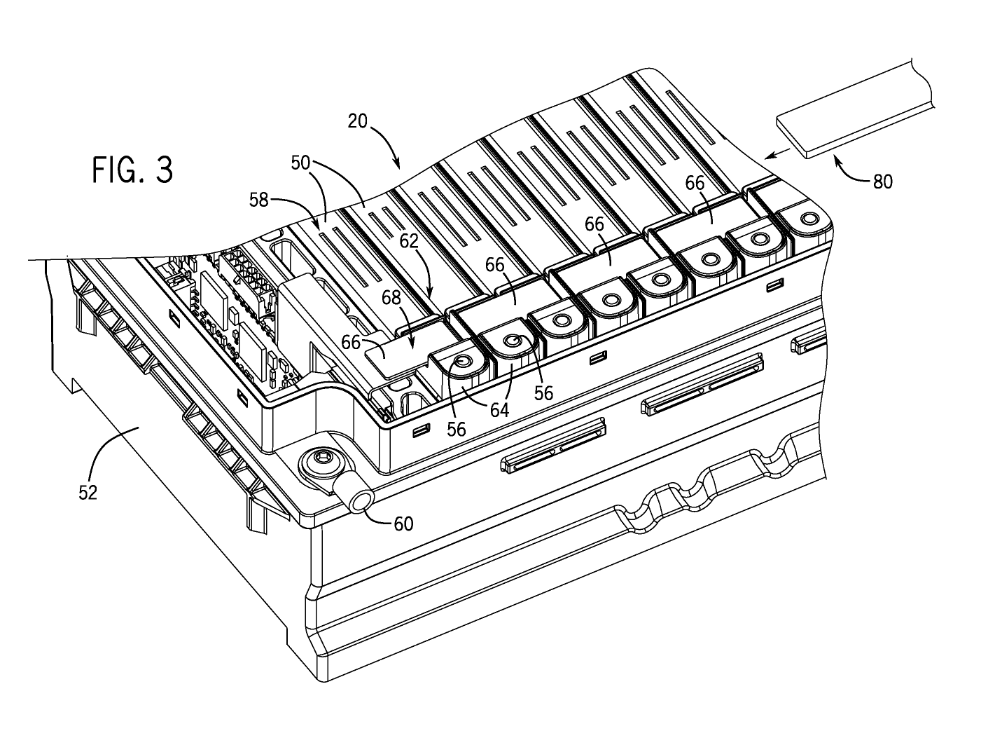

An embodiment of the battery module 20, before an electrically insulative shield 80 is disposed over cell terminals, is shown in a perspective view in FIG. 3. In the illustrated embodiment, the battery module 20 includes a number of individual prismatic electrochemical cells 50 (e.g., Li-ion electrochemical cells 50) housed in a housing 52. Each electrochemical cell 50 may include a positive terminal 54 and a negative terminal 56. The prismatic electrochemical cells 50 also generally include terminal ends 58 having the terminals 54, 56, base ends opposite the terminal ends 58, broad faces extending between the terminal ends 58 and base ends, and narrow faces extending between the broad faces.

In the illustrated embodiment, a first terminal (e.g., the positive terminal 54) of a first electrochemical cell is positioned proximate a second terminal (e.g., the negative terminal 56) of a second electrochemical cell. In this regard, depending on the embodiment, the electrochemical cells 50 may be coupled together in series (e.g., positive terminal 54 to negative terminal 56, as shown) or in parallel (e.g., positive terminal 54 to positive terminal 54 or negative terminal 56 to negative terminal 56). In some embodiments, the battery module 20 may include some electrochemical cells 50 coupled together in parallel and some electrochemical cells 50 coupled together in series. To couple two adjacent electrochemical cells 50 in series, an electrical path is provided between the positive terminal 54 of a first of the two adjacent electrochemical cells 50 and the negative terminal 56 of a second of the two adjacent electrochemical cells 50. To couple two adjacent electrochemical cells 50 in parallel, an electrical path is provided between, for example, the positive terminal 54 of a first of the two adjacent electrochemical cells 50 and the positive terminal 54 of a second of the two adjacent electrochemical cells 50. Alternatively, two adjacent electrochemical cells 50 may also be coupled together in parallel by providing an electrical path between their respective negative terminals 56 as opposed to between their respective positive terminals 54.

It should be noted that the labeled positive terminal 54 in the illustrated embodiment is also electrically coupled to an external terminal 60 of the battery module 20 (e.g., a battery module terminal), where the external terminal 60 is configured to be coupled to, for example, one or more loads (e.g., the vehicle console 16). In general, connections between the electrochemical cells 50 are replicated between all the terminals 54, 56 of all the electrochemical cells 50 of the battery module 20 to form an aggregate electrical network of connections. A negative terminal 56 on the other side of the battery module 20 (e.g., on the other side of the aggregate electrical network) opposite to the illustrated external terminal 60 may be coupled to another external terminal 60 (e.g., a negative external terminal of the battery module 20). The two external terminals 60 may be coupled to the one or more loads such that the aggregate network of connections of the electrochemical cells 50 may enable a charge to be provided from the battery module 20 to the one or more loads. In this manner, each terminal 54, 56 on the exterior of each electrochemical cell 50 represents an electrical contact to the aggregated network of connections of the battery module 20.

In the illustrated embodiment, the electrochemical cells 50 are coupled together in series in accordance with the description above. For example, each electrochemical cell 50 includes a positive terminal 54 coupled to the negative terminal 56 of an adjacent cell 50 and a negative terminal 56 coupled to the positive terminal 54 of the other adjacent cell 50. The electrochemical cells 50 may be disposed in one or more rows such that the electrochemical cells 50 on either end of a row are adjacent to only one electrochemical cell 50.

To couple terminals 54, 56 of adjacent electrochemical cells 50 in the illustrated embodiment, an electrical path is provided between the terminals 54, 56 via a bus bar connection assembly 62 in accordance with the present disclosure. The bus bar connection assembly 62, for example, is configured to provide the electrical path between the respective first terminal 54 (e.g., a positive terminal) of a first cell of the electrochemical cells 50 and the respective second terminal 56 (e.g., a negative terminal) of a second cell of the electrochemical cells 50. However, it should be noted that the disclosed bus bar connection assembly 62 may be used to couple (e.g., provide an electrical path between) two positive terminals 54 or two negative terminals 56 in a parallel connection, or a positive terminal 54 and a negative terminal 56 in a series connection (as shown). Further, the bus bar connection assembly 62, as described in detail below, may be used to couple terminals 54, 56 having the same or two different materials.

The bus bar connection assembly 62, in the illustrated embodiment, includes adapters 64 configured to fit over the terminals 54, 56 of the adjacent electrochemical cells 50. The adapters 64 each include at least a conductive portion (e.g., a metallic portion) configured to contact the terminals 54, 56 of the electrochemical cells 50, which are also conductive (e.g., metallic), and establish an electrical path between the terminals 54, 56. Thus, each electrochemical cell 50 is electrically coupled to the adapters 64 that fit around its respective terminals 54, 56. To electrically couple two adjacent adapters 64 (e.g., the first adapter 64 over the first terminal 54 of the first electrochemical cell 50 and the second adapter 64 over the second terminal 56 of the adjacent second electrochemical cell 50), a bus bar 66 (e.g., a metallic, bi-metallic, alloyed, or otherwise conductive bus bar) is disposed in recesses 68 of the two adjacent adapters 64.

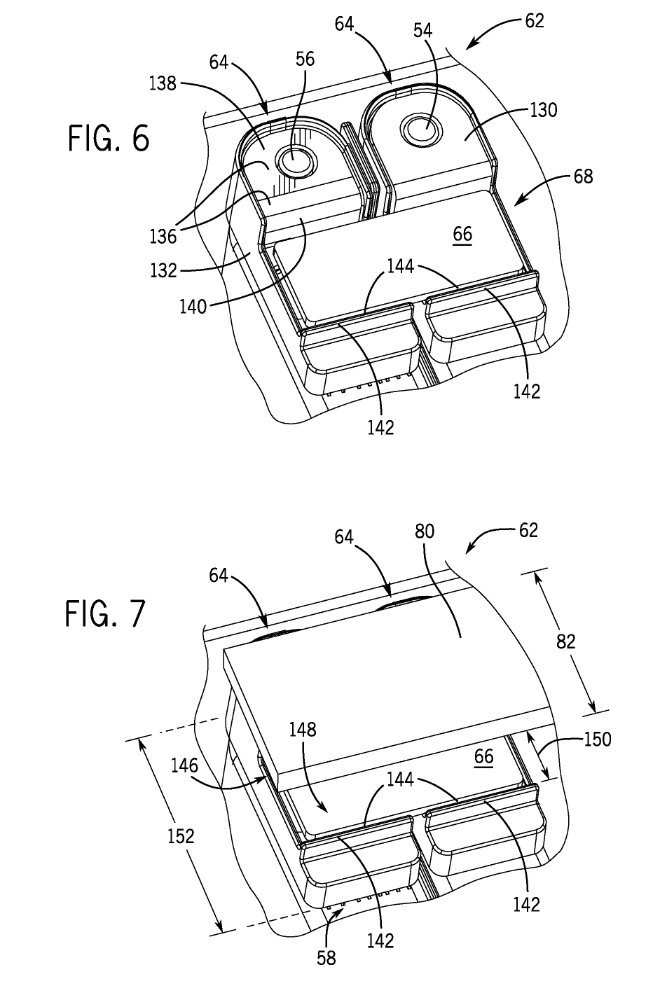

Also included on each adapter 64 in the illustrated embodiment is electrically insulative material configured to block potential short circuits. For example, each adapter 64 in the illustrated embodiment includes a plastic or otherwise electrically insulative material (e.g., dielectric material) disposed around the metallic portion of the adapter 64. For the purpose of the present disclosure, an “electrically insulative material” includes materials that do not substantially transmit electric current therethrough. The electrically insulative material may extend upwardly proximate the recess 68 of the adapter 64 and the conductive bus bar 66 disposed in the recess 68. Accordingly, the electrical path provided between the two terminals 54, 56 of the adjacent electrochemical cells 50 is protected by the electrically insulative material. The conductive (e.g., metallic) and insulative (e.g., plastic) portions of the adapter 64 are discussed in more detail herein with reference to FIG. 6.

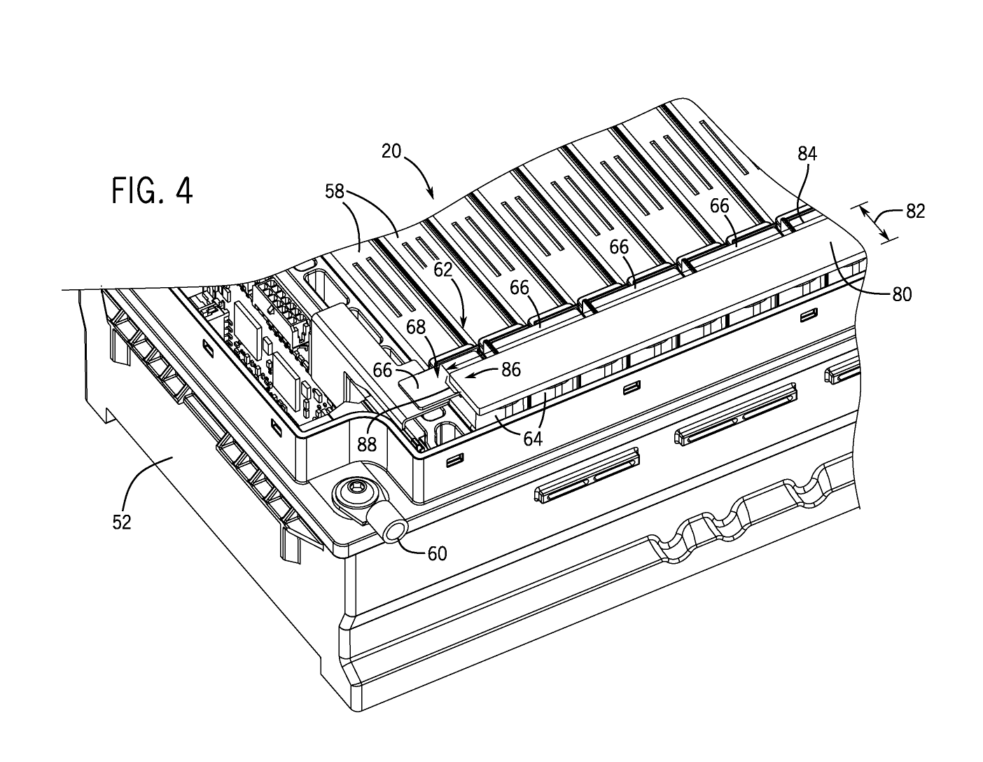

Moreover, FIG. 4 illustrates a perspective view of the battery module 20 of FIG. 3 with an electrically insulative shield 80 disposed over the terminals 54, 56 to provide additional protection from a short circuit. As described above, the adapters 64 may be coupled (e.g., welded) to the bus bar 66 to establish an electrical connection between two battery cells 50. However, when the cell terminals 54, 56 are exposed during the coupling operation, a risk of a short circuit occurring may be increased. For example, a short circuit may be caused when a conductive material comes into contact with an electrical pathway. Welding, in some cases, can cause spatter, or small particles of molten metal (e.g., from a weld wire), that may project beyond the welding area. Therefore, if spatter from a welding operation, for example, were to contact the terminals 54, 56, a short circuit may occur. A short circuit may cause damage to the battery module 20 (e.g., gas and electrolyte may be released from the battery module 20 and/or the battery module 20 may overheat) and could potentially lead to destruction of the functionality of the battery cells 50 (e.g., damage as a result of overheating or release of energy). It is now recognized that positioning the electrically insulative shield 80 over the terminals 54, 56 may reduce a risk of conductive components (e.g., weld spatter) contacting the terminals 54, 56 (e.g., the electrical pathway) during the coupling operation.

The electrically insulative shield 80 may include an insulative material that does not substantially transmit electrical current therethrough and does not melt at high temperatures. In certain embodiments, the insulative material of the electrically insulative shield 80 may be the same material as the insulative portion of the adapters 64. For example, the electrically insulative shield 80 may include any insulating polymeric material (e.g., rubber, foam, or silicone), thermoplastic (e.g., polyethylene or polypropylene), thermoset (e.g., phenolic or other high temperature plastics), a fiber based insulator (e.g., flame retardant papers), a mineral based insulator (e.g., porcelain or mica), or any combination thereof. In certain embodiments, the insulative portions of the adapters 64 may be positioned proximate to the electrically insulative shield 80. In other embodiments, the insulative portions of the adapters 64 may interface with (e.g., contact) the electrically insulative shield 80. In still further embodiments, the position of the insulative portions of the adapters may bear no relationship to the electrically insulative shield 80. In any event, a combination of the insulative portions of the adapters 64 and the electrically insulative shield 80 may prevent short circuits during assembly of the battery module 20.

The electrically insulative shield 80 has a width 82 and a length 84. A portion of the width 82 of the electrically insulative shield 80 may be defined as a ledge 86 that extends over the recesses 68 of the adapters 64. For example, the ledge 86 may extend a distance 88 over the recesses 68. The distance 88 may be configured to enable sufficient protection of the terminals 54, 56, while still providing enough space so that the bus bar 66 may be disposed over both the adapter 64 of the first terminal 54 and the adapter 64 of the second terminal 56. Additionally, the distance 88 may be configured to enable access to the bus bar 66 disposed in the recesses 68, so that the coupling operation may occur without considerable obstruction.

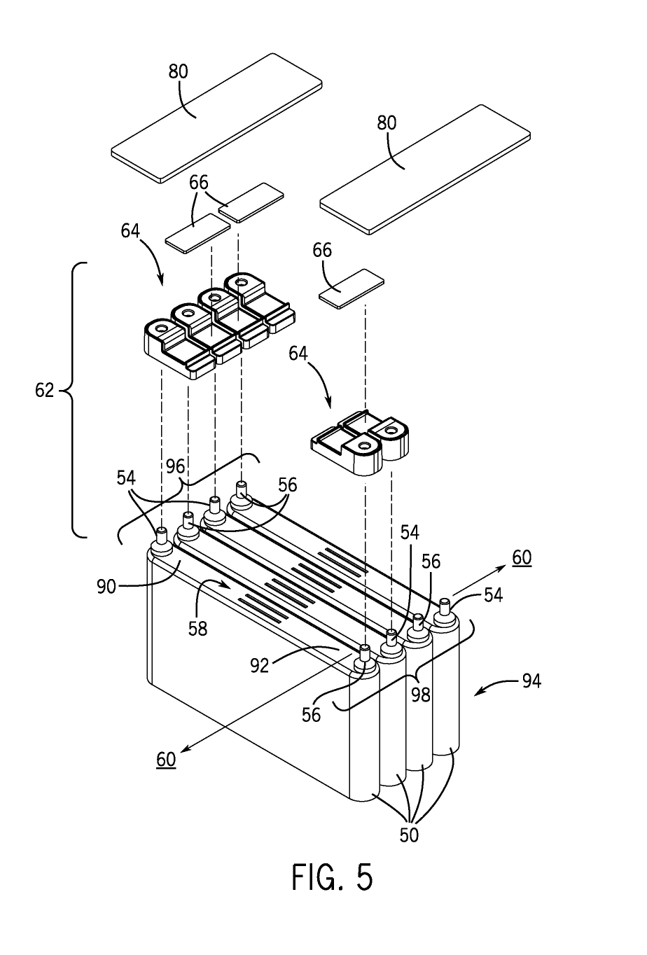

In certain embodiments, the battery module 20 may include two electrically insulative shields 80. In other embodiments, the battery module may include any suitable number of electrically insulative shields 80 to cover all exposed terminals 54, 56 during assembly. For example, the electrochemical cells 50 may be prismatic electrochemical cells having terminals on each side of the terminal ends 58, as illustrated in FIG. 5. FIG. 5 illustrates an exploded perspective view of the battery module 20 having two electrically insulative shields 80. Each of the cells 50 in the illustrated embodiment include a positive terminal 54 and a negative terminal 56, where the positive terminal 54 is on a first side 90 of the terminal end 58 and the negative terminal 56 is on a second side 92 of the terminal end 58. As discussed above, the electrochemical cells 50 may be stacked in a row or a stack 94. Therefore, the stack 94 includes a first row of terminals 96 (and corresponding adapters and bus bars) and a second row of terminals 98 (and corresponding adapters and bus bars), one on either side 90, 92 of the stack 94. In embodiments including prismatic electrochemical cells, the battery module 20 may include a second electrically insulative shield 80, so that the terminals 54, 56 on both sides 90, 92 of the terminal ends 58 of the cells 50 may be covered to enable prevention of a short circuit.

As described previously, the electrically insulative shield(s) 80 may be disposed over the terminals 54, 56 to cover the terminals 54, 56 when the bus bar 66 is welded to the adapters 64 to reduce the risk of short circuit. For example, the electrically insulative shield 80 may be placed over the first row 96 and a second electrically insulative shield 80 may be disposed over the second row 98 of terminals. Accordingly, both rows 96, 98 of terminals 54, 56 may be protected from contact with a conductive component (e.g., weld spatter) that may result when coupling (e.g., welding) the bus bar 66 to the adapters 64.

In certain embodiments, other features of the battery module 20 may also provide protection against short circuits. For example, as shown in FIG. 6, the adapters 64 may include both a conductive portion 130 and an insulative portion 132. The conductive portion 130 may enable a connection to be established between the terminals 54, 56, whereas the insulative portion 132 may provide protection against short circuits. For example, FIG. 6 illustrates the adapters 64 as including the conductive portion 130 and the insulative portion 132. As discussed previously, the adapters 64 are configured to couple the first terminal 54 with the adjacent second terminal 56. However, in certain embodiments, the first terminal 54 may have a first conductive material and the second terminal 56 may have a second conductive material, different from the first conductive material. For example, the first terminal 54 may be aluminum and the second terminal 56 may be copper. In other embodiments, the first terminal 54 and the second terminal 56 may include the same conductive material (e.g., both have aluminum or both have copper).

As will be appreciated by those of skill in the art, an electrochemical half-reaction occurs at each of the positive and negative electrodes. For example, the electrochemical half-reaction at the positive electrode may be a reaction in which one or more lithium ions are reversibly (based on an equilibrium) dissociated from the positive electrode active material, thereby also releasing one or more electrons (equal in number to the number of dissociated lithium ions). At the negative electrode, the electrochemical half-reaction that occurs may be a reaction in which one or more lithium ions and one or more electrons (of equal number) are reversibly associated with the negative electrode active material (e.g., carbon). During discharging of the battery, the equilibria at the electrodes favor dissociation of the lithium ions and electrons from the negative electrode active material and re-association of the electrons and lithium ions with the positive electrode active material. On the other hand, during charging, the reverse is true. The movement of the ions into the electrodes is commonly referred to as intercalation or insertion, and the movement of the ions away from the electrodes is commonly referred to as deintercalation or extraction. Accordingly, during discharging, intercalation occurs at the positive electrode and deintercalation occurs at the negative electrode, and during charging, the reverse is true. Therefore, the positive and negative electrodes of the present batteries will generally be capable of lithium ion intercalation and deintercalation. As will also be appreciated, the particular materials selected for a current collector for each of the positive and negative electrodes will also depend on the particular materials used as their respective active materials. For instance, for a cathode with NMC active material, the current collector (e.g. the first terminal 54) may be aluminum, while for an anode with graphite active material, the current collector (e.g., the second terminal 56) may be copper.

As previously described, in accordance with present embodiments, the electrical path between the two terminals 54, 56 is generally established via the adapters 64. The adapter 64 that fits over (or around) the first terminal 54, in the illustrated embodiment, may also include the first conductive material (e.g., aluminum). In particular, the conductive portion 130 (e.g., metallic portion) of the adapter 64 may include the first conductive material (e.g., aluminum, or the same conductive material as the terminal 54). In certain embodiments, the adapter 64 that fits over (or around) the second terminal 56, in the illustrated embodiment, may include the second conductive material (e.g., copper). However, in some cases, coupling two different conductive materials together can create undesirable galvanic effects.

Therefore, in other embodiments, the adapter 64 that fits over (or around) the first terminal 54 and/or the second terminal 56 may include a bi-material (e.g., bi-metallic) conductive portion 136 (e.g., as illustrated on terminal 56) to minimize any undesirable galvanic effects. The bi-metallic portion 136 includes a first conductive portion 138 (e.g., having the second conductive material, copper) that contacts the first terminal 54 or second terminal 56, and a second conductive portion 140 that contacts the bus bar 66. The first conductive portion 138 may transition to the second conductive portion 140 (e.g., the first conductive material, aluminum) proximate to the recess 68 of the adapter 64. Thus, each recess 68 (e.g., recessed portion) of the two adjacent adapters 64 may include the same material (e.g., aluminum).

In certain embodiments, the conductive bus bar 66 also includes, for example, the first conductive material (e.g., aluminum) to correspond with the conductive material in the recessed portions 68 in each of the adapters 64. Accordingly, in embodiments where the adapters 64 have the bi-metallic conductive portion 136, the first conductive portion 138 may be configured to transition to the second conductive portion 140, so that the conductive material in the recess 68 corresponds with the conductive material of the bus bar 66. The conductive and bi-material conductive portions 130, 136 may include any conductive material(s), but, for simplicity, may be referred to as metallic and bi-metallic portions 130, 136 herein.

It should be noted that, in the embodiment illustrated in FIG. 6, the electrochemical cells 50 may be coupled together in series or in parallel, as previously described. For example, depending on the electrochemically-active materials (e.g., anode and cathode active material) of the electrochemical cell 50, the electrochemical cell 50 may include two copper terminals 54, 56, two aluminum terminals 54, 56, one copper terminal 54/56 and one aluminum terminal 56/54, or two terminals 54, 56 having the same or different other materials. In general, the internal chemistry, among other factors, determines the type of material used for each terminal 54, 56 (e.g., of the anode and cathode). Accordingly, depending on the embodiment, two terminals 54, 56 having the same material may be electrically coupled to couple cells in series or in parallel, and two terminals 54, 56 having different materials may be electrically coupled to couple cells in series or in parallel. In this regard, battery modules in accordance with the present disclosure may include multiple types of adapters and/or bus bars.

As described above, the adapters 64 may include the insulative portion 132 to block external, loose, or proximate materials or parts from contacting the conductive portions 130, 136 of the adapters 64, which could otherwise cause a potential short circuit. The electrically insulative portion 132 (e.g., having plastic) may surround, for example, outer sides of the adapter 64. The electrically insulative portion 132 may also include a wall 142 that extends upwardly from the adapter 64 (e.g., in a direction parallel to the terminals 54, 56 extending upwardly from the cells 50) proximate the recess 68 of the adapter 64. The wall 142 may partially define the recess 68 or recessed portion configured to receive the bus bar 66 and may be disposed proximate a far side 144 of the bus bar 66 and recessed portion 68 of the adapter 64. It should be noted that, regardless of whether metal or bi-metal portions 130, 136 are used, the adapters 64 may include the same or similar plastic (or otherwise non-conductive) portions 132 and corresponding walls 142 to block or reduce a likelihood of a short circuit. Additionally, the insulative material used in the insulative portion 132 may be the same as the insulative material used for the electrically insulative shield 80 (e.g., plastic, rubber, silicone, foam, or any combination thereof). The illustrated embodiments and corresponding description are not included to be limited to the combination of elements shown. Rather, the disclosed elements of the bus bar connection assembly 62 may be used in various combinations as appropriate for electrochemical cells 50 coupled in series, coupled in parallel, having terminals 54, 56 with corresponding materials, or having terminals 54, 56 with different materials.

FIG. 7 is a top perspective view of the of the bus bar connection assembly 62 of FIG. 6 having the electrically insulative shield 80 disposed over the terminals 54 and 56. The electrically insulative shield 80 is disposed over the terminals 54, 56, such that the electrically insulative shield 80 contacts tops of the terminals 54, 56, as shown in FIG. 7. Accordingly, the electrically insulative shield 80 may form a gap 146 with the bus bar 66 as a result of the recesses 68. In other words, the recesses 68 enable a gap 146 to be formed between the electrically insulative shield 80 and the bus bar 66 to enable access to a top surface 148 of the bus bar 66.

As shown in the illustrated embodiment, the electrically insulative shield 80 may be disposed over the tops of the terminals 54, 56, such that the terminals 54, 56 are fully covered. However, in certain embodiments, a portion 150 of the bus bar 66 may remain exposed (e.g., extends further along the terminal ends 58 than the width 82 of the electrically insulative shield 80). For example, the adapters 64 may extend a distance 152 along the terminal ends 58 of the battery cells 50. In certain embodiments, the width 82 of the electrically insulative shield 80 may cover only a portion of the distance 152, such that the portion 150 of the bus bar 66 is exposed, facilitating access to the bus bar 66. In other embodiments, the electrically insulative shield 80 may cover the entire distance 152. In any event, the gap 146 between the electrically insulative shield 80 and the bus bar 66 is formed and provides access to the bus bar 66, while the terminals 54, 56 are fully covered and protected by the electrically insulative shield 80. Accordingly, when the bus bar 66 is coupled to the adapters 64, the electrically insulative shield 80 blocks any components from contacting an electrical path between the terminals 54, 56 and thereby reduces a risk of a short circuit.

For example, the bus bar 66 may be welded to the adapters 64, creating weld spatter. The electrically insulative shield 80 may then block any spatter from coming into contact with either terminal 54, 56, and prevent a short circuit from occurring. Additionally, the electrically insulative shield 80 may block any other conductive debris or component that may be present during the assembly of the battery module 20 from contacting the terminals 54, 56. Moreover, the electrically insulative shield 80 may block components from contacting the terminals 54, 56 when another bus bar 66 is being welded to adapters 64 of other terminals (e.g., terminals on an opposite side 90, 92 of the battery cells 50, or terminals adjacent to terminals 54, 56).

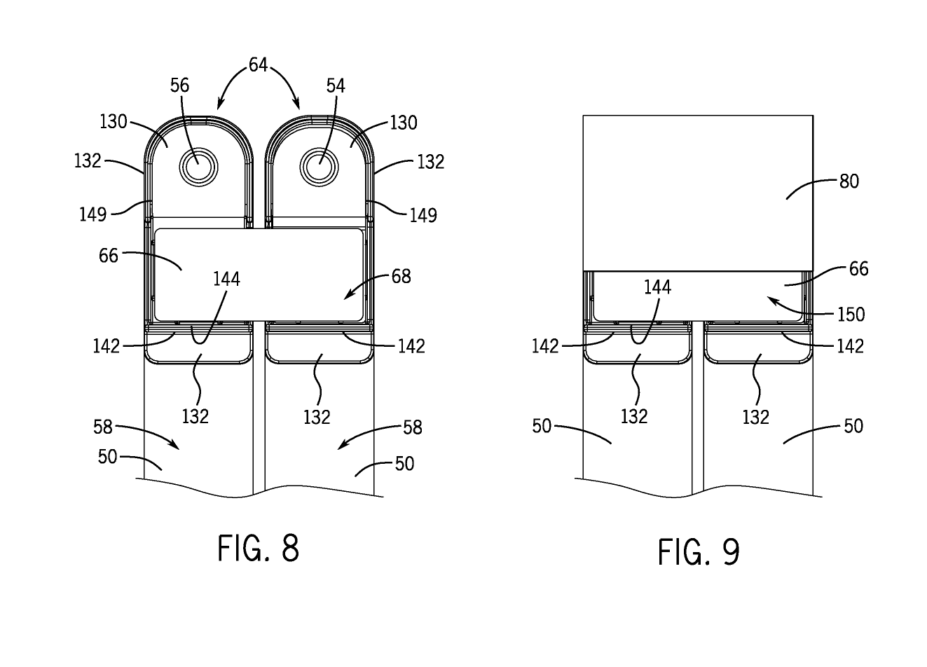

As described above, the bus bar 66 is configured to be disposed within, and span between, the two recesses 68 of the adjacent adapters 64 to form the electrical connection between the terminals 54, 56. For example, a top view of an embodiment of the bus bar connection assembly 62 having the bus bar 66 spanning between two recesses 68 of adjacent adapters 64 is shown in FIG. 8. In the illustrated embodiment, the bus bar 66, and the conductive (e.g., metallic) portions 130 of the adapters 64 (e.g., the electrical path) is at least partially protected from a short circuit via the insulative (e.g., plastic) portions 132 of the adapters 64. For example, the insulative portions 132 substantially surround outer surfaces or edges 149 of the adapters 64. Additionally, the insulative portions 132 include the walls 142 that extend upwardly from the adapters 64 proximate the far side or far edge 144 of the bus bar 66 (or recesses 68). The walls 142 are configured to provide additional protection from a short circuit, but may also be configured to guide placement and securement (e.g., via welding, adhesive) of the bus bar 66 into the recesses 68 of the adjacent adapters 64. It should be noted that the insulative portions 132 and corresponding walls 142 may not cover a top portion of the metallic portions 130 (or bi-metallic portions 136) of the adapters 64, such that the bus bar 66 may be placed into the recesses 68 and accessed from above the electrochemical cells 50 for securing the bus bar 66 (e.g., via welding, adhesive) to the adapters 64. However, generally the recesses 68 of the adapters 64 and the insulative portions 132 (and corresponding walls 142) surrounding the metallic/bi-metallic portions 130, 136 of the adapters 64 are configured to protect the electrical path between the two terminals 54, 56 from being contacted by other components.

Additionally, the electrically insulative shield 80 reduces the risk that components will contact the electrical path between the terminals 54, 56 during the coupling operation of the bus bar 66 to the adapters 64. A top view of the electrically insulative shield 80 disposed over the terminals 54, 56 is illustrated in FIG. 9. As shown in the illustrated embodiment, the electrically insulative shield 80 may cover a portion of the bus bar 66, such that the portion 150 is exposed from the top. Accordingly, an assembler (e.g., a person or a machine) may access the bus bar 66, via the portion 150, and couple (e.g., weld) the bus bar 66 to the adapters 64. Moreover, the electrically insulative shield 80 fully covers the terminals 54, 56, thereby protecting the terminals 54, 56 from contact with a conductive component (e.g., weld spatter) that may cause a short circuit.

It should be noted that the electrically insulative shield 80 may be disposed over the terminals 54, 56 during assembly of the battery module 20 and then removed upon completion of assembly. In other embodiments, the electrically insulative shield 80 may be a permanent component of the battery module 20 that remains positioned over the terminals 54, 56 even upon completion of assembly.

While providing enhanced protection against short circuits, embodiments of the present disclosure may also increase the energy density of the battery module 20. For instance, by disposing the bus bars 66 within the recesses 68 of the adapters 64, the bus bars 66 may be disposed in-line with (e.g., flush) or below the terminals 54, 56, instead of on top of (e.g., in contact with) or above the terminals 54, 56. Thus, in embodiments where the electrically insulative shield 80 is removed upon completion of assembly, a height of the battery module 20 may be reduced, thereby comparatively reducing the volume and increasing the energy density of the battery module 20. Further, in some embodiments, each electrochemical cell 50 of the battery module 20 may include slightly different widths (e.g., within manufacturing tolerances). Since the bus bar 66 sits within recesses 68 of the adapters 64 (e.g., as opposed to being rigidly connected between the terminals 54, 56 of the electrochemical cells 50), the electrochemical cells 50 (and adapters 64 thereof) may be positioned immediately adjacent one another before coupling the bus bar 66 to the recessed portions 68. Thus, in accordance with the present disclosure, space is saved between the electrochemical cells 50 and an energy density of the battery module 20 is increased.

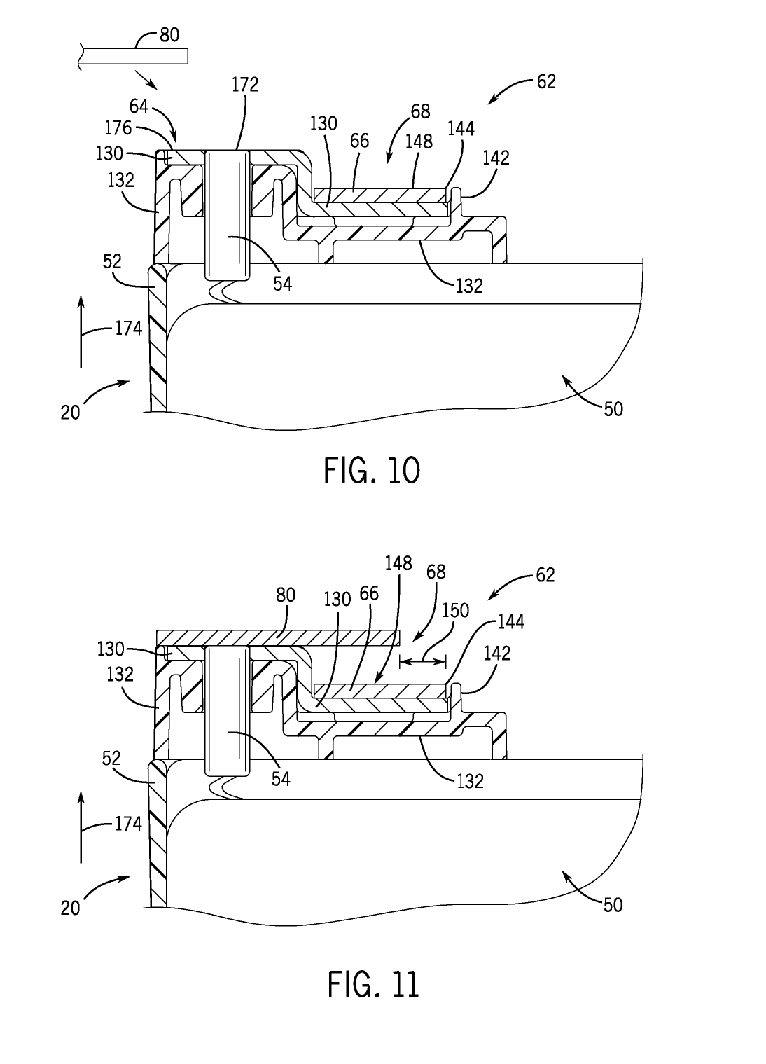

The reduced height by the present connection assembly may be further appreciated with respect to FIG. 10, which is a cross-sectional side view of one electrochemical cell 50 of the battery module 20 having the corresponding adapter 64 and the electrically insulative shield 80 in the process of being positioned over the cell 50. In the illustrated embodiment, the top surface 148 of the bus bar 66 is disposed below a top surface 172 of the terminal 54 with respect to vertical axis 174. The top surface 172 of the terminal 54, in the illustrated embodiment, is flush (e.g., in-line or in-plane) with a top surface 176 of the adapter 64. Accordingly, all components of the bus bar connection assembly 62 are disposed in-line with and/or below the top surface 172 of the terminal 54 (with respect to the vertical axis 174), thereby reducing a clearance of the illustrated electrochemical cell 50 compared to other arrangements where terminals are fitted directly (and/or rigidly) with a bus bar. The reduced clearance reduces a height and, thus, a volume of the battery module 20, thereby increasing the energy density of the battery module 20.

Additionally, as illustrated in FIG. 11, when the bus bars 66 are coupled (e.g., welded) to the adapters 64, the electrically insulative shield 80 may be disposed over the terminal 54. As discussed previously, the electrically insulative shield 80 may protect the terminal 54 from contact with an undesirable component (e.g., weld spatter) to decrease a risk of short circuit. Additionally, the electrically insulative shield 80 may be removed upon completion of assembly of the battery module 20, such that the battery module 20 includes the reduced height discussed above, and thus has an enhanced energy density.

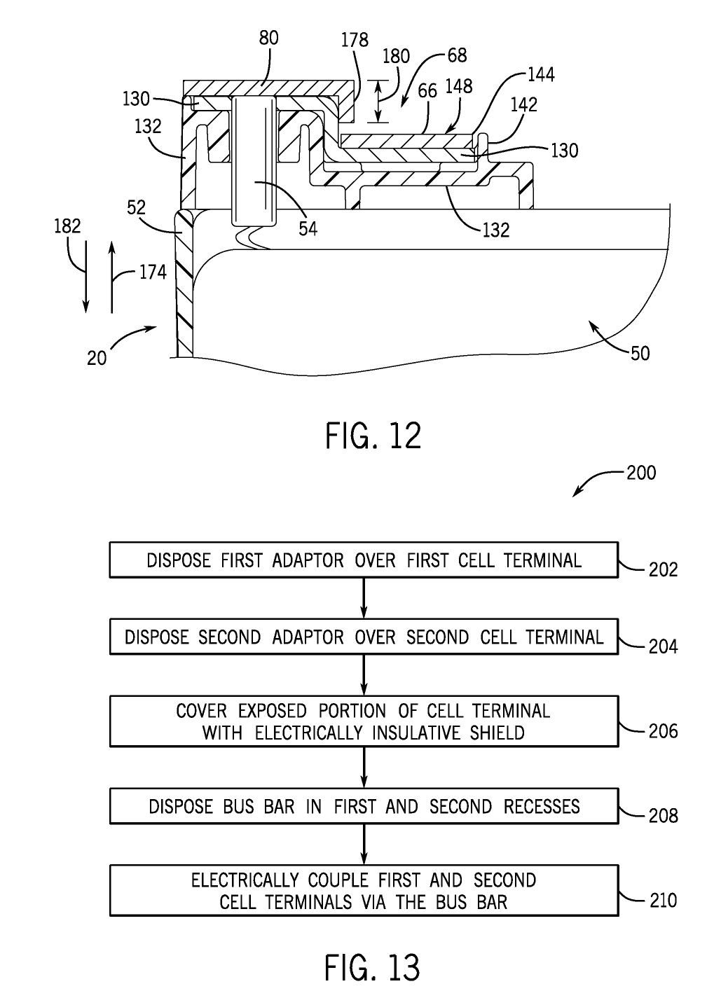

FIG. 12 illustrates an embodiment of the electrically insulative shield 80 disposed over the terminal 54 when the bus bars 66 are coupled (e.g., welded) to the adapters 64. In the illustrated embodiment of FIG. 12, the electrically insulative shield 80 includes a lip portion 178 that extends a distance 180 in a direction 182, opposite of direction 174, into the recess 68. In some instances, the electrically conductive shield 80 may not lay directly flat on top of the conductive portion 130, thereby potentially exposing the terminal 54 via openings between the electrically conductive shield 80 and the conductive portion 130. Accordingly, the lip portion 178 may further protect the terminal 54 from a short circuit by adding another barrier to the conductive material and blocking conductive material from entering any openings between the electrically conductive shield 80 and the conductive portion 130.

In certain embodiments, the lip portion 178 may contact the conductive portion 130 to prevent a gap from forming between the electrically conductive shield 80 and the conductive portion 130. Eliminating a gap between the lip portion 178 and the conductive portion 130 may further protect the terminal 54 from a short circuit. However, in other embodiments, a small gap (e.g., a gap unlikely to create access to the terminal 54) between the lip portion 178 and the conductive portion 130 may be formed.

FIG. 13 illustrates a flow chart 200 of a process for assembling the battery module 20, in accordance with an aspect of the present disclosure. At block 202, a first adapter 64 may be disposed over a first cell terminal 54, 56. As discussed above, the first adapter 64 may include the conductive portion 130, the insulative portion 132, and the recess 68. Additionally, at block 204, a second adapter 64 may be disposed over a second cell terminal 54, 56. Similarly, the second adapter 64 may also include the conductive portion 130, the insulative portion 132, and the recess 68. At block 206, the first and second cell terminals 54, 56 are covered by the electrically insulative shield 80. The electrically insulative shield 80 may be configured to cover the terminals 54, 56 to reduce the risk of a short circuit. At block 208, a bus bar 66 may be disposed in the recesses 68 of the first and second adapters 64. It should be noted that the bus bar 66 may be disposed in the recesses 68 either before or after the electrically insulative shield 80 is disposed over the cell terminals 54, 56. Additionally, at block 210, the bus bar 66 may be coupled to the first and second adapters 64, via the conductive portions 130 of the first and second adapters 64. In certain embodiments, the bus bar 66 may be welded to the conductive portions 130. Accordingly, to prevent weld spatter from contacting the terminals 54, 56, the electrically insulative shield 80 is positioned on top of, or above, the terminals 54, 56 to block any weld spatter (or any other conductive material) from contacting the terminals 54, 56 and causing a short circuit.

As discussed above, once the bus bar 66 is coupled to the first and second adapters 64 (e.g., welding the bus bar 66 to the conductive portions 130), the electrically insulative shield 80 may be removed from the battery module 20. Accordingly, an overall height of the battery module 20 may be reduced, such that the energy density may be enhanced. In other embodiments, the electrically insulative shield 80 may, however, be fixed over the cell terminals 54, 56 (e.g., not removed from the battery module 20).

Additionally, the process depicted by the flow chart 200 may also include disposing a third adapter 64 over a third cell terminal 54, 56 and disposing a fourth adapter 64 over a fourth cell terminal 54, 56. In certain embodiments, the third cell terminal 54, 56 may be positioned on the same battery cell as the first cell terminal 54, 56, but on an opposite side of the terminal end 58. Similarly, the fourth cell terminal 54, 56 may be positioned on the same battery cell as the second cell terminal 54, 56, but on an opposite side of the terminal end 58. Accordingly, the electrically insulative shield 80 may be repositioned to cover the third and fourth cell terminals 54, 56 when a second bus bar 66 is coupled to the third and fourth adapters 64 (e.g., via the conductive portions 130 of the third and fourth adapters). The third and fourth cell terminals 54, 56 are thus protected from a short circuit when the third and fourth adapters 64 are coupled to the second bus bar 66.

In other embodiments having the third and fourth cell terminals 54, 56, the battery module 20 may include a second insulative shield 80 that covers the third and fourth cell terminals 54, 56 during the coupling of the first and second adapters 64 to the first bus bar 66 (e.g., via the conductive portions 130 of the third and fourth adapters 64) and during the coupling of the third and fourth adapters 64 to the second bus bar 66 (e.g., via the conductive portions 130 of the third and fourth adapters). Utilizing the second electronically insulative shield 80 may provide further protection from a short circuit because it enables all cell terminals 54, 56 to be covered during the coupling operation, and not just the terminals 54, 56, whose corresponding adapters 64 are currently being coupled to a bus bar 66.

One or more of the disclosed embodiments, alone or in combination, may provide one or more technical effects useful in the manufacture of battery modules, and portions of battery modules. The disclosed embodiments relate to features of a battery module that may reduce the risk of a short circuit during assembly of the battery module. Such features may prevent potential damage to the battery cells, thereby decreasing production losses. The technical effects and technical problems in the specification are exemplary and are not limiting. It should be noted that the embodiments described in the specification may have other technical effects and can solve other technical problems.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A battery module, comprising:
a first battery cell having a first cell terminal;
a second battery cell having a second cell terminal;
a first adapter disposed about the first cell terminal, wherein the first adapter comprises a first recess positioned proximate to the first cell terminal;
a second adapter disposed about the second cell terminal, wherein the second adapter comprises a second recess positioned proximate to the second cell terminal;
a bus bar configured to electrically couple the first cell terminal to the second cell terminal via the first and second recesses; and
an electrically insulative shield configured to cover the first cell terminal and the second cell terminal when the bus bar is being coupled to the first and second recesses to prevent a short circuit.

2. The battery module of claim 1, wherein the first adapter comprises a first conductive portion in contact with the first cell terminal, the second adapter comprises a second conductive portion in contact with the second cell terminal, and the bus bar is in electric contact with the first conductive portion and the second conductive portion when being coupled to the first and second recesses.

3. The battery module of claim 2, wherein a first end of the bus bar is configured to be welded to the first conductive portion and a second end of the bus bar is configured to be welded to the second conductive portion.

4. The battery module of claim 2, wherein the first adapter comprises a first electrically insulative portion at least partially surrounding the first conductive portion, the second adapter comprises a second electrically insulative portion at least partially surrounding the second conductive portion.

5. The battery module of claim 4, wherein the first and second electrically insulative portions are disposed proximate to the electrically insulative shield when the bus bar is being coupled to the first and second recesses.

6. The battery module of claim 2, wherein the first conductive material is copper and the second conductive material is aluminum.

7. The battery module of claim 2, wherein the first conductive material is aluminum and the second conductive material is copper.

8. The battery module of claim 1, wherein the first adapter extends a first distance along a first surface of the first battery cell, the second adapter extends a second distance along a second surface of the second battery cell, and the electrically insulative shield covers the first and second distances.

9. The battery module of claim 1, wherein the first and second battery cells are lithium ion electrochemical cells.

10. The battery module of claim 1, wherein the first and second electrochemical cells are prismatic electrochemical cells.

11. The battery module of claim 1, wherein the bus bar is disposed within the first and second recesses such that a top surface of the bus bar is disposed no higher than the top surfaces of the first and second terminals.

12. The battery module of claim 1, wherein the first battery cell comprises a third cell terminal and the second battery cell comprises a fourth cell terminal, the first and second battery cells each comprise a first side and a second side, the first cell terminal is disposed on the first side of the first battery cell, the third cell terminal is disposed on the second side of the first battery cell, the second cell terminal is disposed on the first side of the second battery cell, the fourth cell terminal is disposed on the second side of the second battery cell, and the battery module comprises an additional electrically insulative shield configured to cover the third and fourth battery cells when the bus bar is being coupled to the first and second recesses.

13. The battery module of claim 12, comprising a third adapter dispose about the third cell terminal and a fourth adapter disposed about the fourth cell terminal, wherein the third adapter comprises a third recess positioned proximate to the third cell terminal, the fourth adapter comprises a fourth recess positioned proximate to the fourth cell terminal, and the additional electrically insulative shield is configured to cover the third and fourth cell terminals when the third and fourth recesses are being coupled to an additional bus bar.

14. The battery module of claim 1, wherein the electrically insulative shield comprises plastic.

15. A method for constructing a battery module, comprising:
disposing a first adapter over a first battery cell terminal, wherein the first adapter covers at least a portion of the first battery cell terminal and comprises a first recess positioned proximate to the first battery cell terminal;
disposing a second adapter over a second battery cell terminal, wherein the second adapter covers at least a portion of the second battery cell terminal and comprises a second recess positioned proximate to the second battery cell terminal;
covering a remaining exposed portion of the first battery cell terminal and a remaining exposed portion of the second battery cell terminal with an electrically insulative shield; and
electrically coupling the first battery cell terminal to the second battery cell terminal by disposing a bus bar within the first and second recesses.

16. The method of claim 15, wherein the electrically insulative shield covers only a portion of the bus bar.

17. The method of claim 15, wherein the first adapter comprises a first conductive portion in contact with the first battery cell terminal, the second adapter comprises a second conductive portion in contact with the second battery cell terminal, a first side of the bus bar is welded to the first conductive portion, and a second side of the bus bar is welded to the second conductive portion.

18. The method of claim 17, wherein the electrically insulative shield is disposed over the first and second battery cell terminals, such that a welding tool can access a top face of the bus bar.

19. The method of claim 15, comprising:
disposing a third adapter over a third battery cell terminal, wherein the third adapter covers at least a portion of the third battery cell terminal and comprises a third recess positioned proximate to the third battery cell terminal;
disposing a fourth adapter over a fourth battery cell terminal, wherein the fourth adapter covers at least a portion of the fourth battery cell terminal and comprises a fourth recess positioned proximate to the fourth battery cell terminal;
repositioning the electrically insulative shield to cover the third battery cell terminal and the fourth battery cell terminal; and
electrically coupling the third battery cell terminal to the fourth battery cell terminal by disposing an additional bus bar within the third and fourth recesses.

20. The method of claim 15, comprising leaving the electrically insulative shield in place as a permanent component of the battery module.

21. A battery module, comprising:
a first battery cell having a first cell terminal;
a second battery cell having a second cell terminal;
a first adapter covering at least a portion of the first cell terminal, wherein the first adapter comprises a first recess positioned proximate to the first cell terminal, a first conductive portion in contact with the first cell terminal, and a first insulative portion at least partially surrounding the first conductive portion;
a second adapter covering at least a portion of the second cell terminal, wherein the second adapter comprises a second recess positioned proximate to the second cell terminal, a second conductive portion in contact with the second cell terminal, and a second insulative portion at least partially surrounding the second conductive portion;
a bus bar electrically coupling the first cell terminal to the second cell terminal via the first and second conductive portions; and
an electrically insulative shield covering a remaining exposed portion of the first cell terminal and a remaining exposed portion of the second cell terminal when the bus bar is being coupled to the first and second recesses, wherein the electrically insulative shield comprises a lip portion configured to extend into the first and second recesses.

22. The battery module of claim 21, wherein the first and second insulative portions are disposed proximate to the electrically insulative shield when the bus bar is being coupled to the first and second recesses.

23. The battery module of claim 21, wherein the bus bar is disposed within the first and second recesses such that a top surface of the bus bar is disposed no higher than the top surfaces of the first and second terminals.

24. The battery module of claim 21, wherein the electrically insulative shield comprises plastic.
